(19) United States
(12) Patent Application Publication
(10) Pub. No.: US 2004/0140944 A1
(43) Pub. Date: Jul. 22, 2004

(54) Inverted ground plane system

(76) Inventor: Billy D. Pennington, London, KY (US)

Correspondence Address: BILLY D. PENNINGTON, 176 O'JOHNSON ROAD, LONDON, KY, 40744, US

(21) Appl. No.: 10/348,692

(22) Filed: Jan. 22, 2003

(51) Int. Cl. H01Q 1/48; H01Q 9/30

(52) U.S. Cl. 343/848; 343/900

(57) ABSTRACT

The present invention relates to vertical antenna systems (FIG. 1) employing an improved artificial ground system (10). In a resident frequency design, the ground plane system provided is in the form of a ground plane or diverging element (10). is provided with an efficient, economical and practical electrical conducting radial design (20). A low frequency design. Utilizing a fractional ground plane counterpoise. Folded at an fractional point, (10a) with respects to resident's frequency. At or about a right angle to the upper portion of the ground plane (diverging element (10)) forming a V type diverging element on it's side (>). Oriented with relevant, and beneficial length. To an opposing diverging element (10) in order to maximize gain emitted from the diverging elements, increasing radiation at lower angle's from antenna system (FIG. 1). That can incorporate a capacitance top hat (FIG. 3). Having similar to the diverging elements. Increasing ground wave signal, and lessening sky wave emissions radiated from a an antenna system utilizing the Inverted ground plane system (FIG. 1).

### FIELD OF INVENTION

The present invention relates to antenna systems, and more particularly to vertical antenna systems employing artificial ground means in the form of either a counterpoise, or ground planes.

U.S. PATENTS DOCUMENTS

| | | | |
|---|---|---|---|
| 2,048,726 | Jul. 28, 1936 | O. Bohm | 343/843 |
| 1,912,754 | Jun. 6, 1933 | O. Bohm | 343/826 |
| 6,486,849 | Nov. 26, 2002 | Buckles | 343/808 |
| 4,095,231 | Jun. 13, 1978 | Carter | 343/846 |
| 5,202,696 | Apr. 13, 1993 | Sheriff | 343/741 |
| 4,670,760 | Jun. 2, 1987 | Biby | 343/843 |

### OTHER REFERENCES

The Amateur's Radio Handbook 58^{th} edition 1981, pp. 20-10 FIG. 27. pp. 20-09 FIG. 21. pp. 20-08 FIG. 22.

Teran's Radio Engineer's Hand Book (McGraw-Hill1943,) pp. 793.-795

Simple, and Low-Cost Wire Antennas (RAC 1990,) pp.115.

### BACKGROUND OF INVENTION

The efficient operation of a vertical antenna for transmitting, or receiving requires that the antenna be used in conjunction with a “ground”. The type, size, physical construction and electrical characteristics of the chosen “ground” determine the performance, efficiency, ease of feed and radiation pattern of the antenna system.

Basically there are two requirements for a good “ground plane”. First, the ground must provide a low resistance path for the return of those currents, resulting from the radiated field of the antenna. This is of particular importance at the base of the antenna where the return currents are concentrated. Current flow through the relatively high ground resistance in this area can result in severe and substantial (I.sup.2 R) heat losses. U.S. Pat. No. 1,912,754 to O. Bohm (1933)

Secondly, a good ground system should provide a good electrically reflecting plane to allow the creation of the so called “image antenna”. This increases the signal radiated by the antenna and assures that it is transmitted or received at the desired radiation angle.

Conventional vertical antennas that use the earth as a ground do not provide sufficient and optimum performance. This is because the earth is a relatively poor electrical conductor at low frequencies such as those used by AM broadcast stations, and acts as a dielectric or insulator at high frequencies. Such as used by land mobile radio stations, citizens band radio service, and the higher amateur radio bands.

As opposed to using the earth as a sole “ground plane” source, it has been known to use artificial ground systems in conjunction with vertical antennas. There is no doubt, that artificial ground plane systems do improve the operational efficiency and performance of vertical antennas. U.S. Pat. No. 5,202,696 to Sheriff (1993)

The most commonly used artificial ground plane system comprises a system of electrical wires that radiate outwardly from the base of a vertical antenna. U.S. Pat. No. 4,095,231 to Carter (1978) Antenna return currents flow back towards the base of the antenna along these wires instead of flowing through the adjacent high resistance portion. Research conducted in the past, particularly that reported in 1937 by George H. Brown, determined that for optimum results one should use 3, or more radial wires. Simple and Low-Cost Wire Antenna's (RAC 1990) pp.115. with each being at least one-fourth wavelength long relative to the operating frequency of the antenna system. In fact, this very recommendation for efficient signal radiation as discussed in U.S. Pat. No. 2,048,726 to O. Bohm (1936)

It is appreciated that buried wires provided over a substantial area of the earth can be very expensive and time consuming to install. In view of this, an artificial ground system referred to as a “counterpoise” has been occasionally used in the past. The Radio Amateur's Handbook pp. 20-10 FIG. (1981) 27A counterpoise is an artificial ground system comprising a series of radial wires or other forms of electrical conducting material that is disposed above the earth.

Construction problems associated with providing counterpoises have precluded extensive use of the systems, particularly in low frequency applications. See U.S. Pat. No. 4,670,760 to Biby (1987) Prior to Applicant's invention, and the research and development work associated therewith, there was little, if any, data or information concerning the electrical, and performance characteristics, and properties of the counterpoise. Because of the absence of this data, technology and information, it has been difficult for individuals to design a reliable counterpoise artificial ground systems based on existing design criteria, and parameters.

It should also be pointed out that the so called “elongated radial elements” has also been occasionally used as an antenna system. The “elongated radial elements” may be physically similar to a counterpoise, but is designed such that its wires are typically used in a fashion where the wires reach upward to vicinity of the antenna, at which time the wires extend up above center to form the ground element. Again, as in the case with the elongated radial elements, there was very little, prior information and literature available concerning electrical performance characteristics of the multi element radiator. U.S. Pat. No. 6,486,849 to Buckles (2002)

### SUMMARY AND OBJECTS OF THE PRESENT INVENTION

The present invention entails a vertical antenna having a very efficient artificial ground system that is generally referred to as a counterpoise, or in some cases as a “ground screen” where there is a direct attachment to the earth. Of particular importance and significance is the fact that the artificial ground system of the present invention is derived from and based on a substantial research and testing directed at identifying and defining important design criteria, and parameters useful in designing various types of artificial ground systems for antennas. In addition, the present invention presents a number of optional designs with artificial ground systems for a wide range of frequencies.

It is therefore an object of the present invention to provide a vertical antenna with an improved artificial ground system. In the form of a counterpoise or ground screen.

Another object of the present invention resides in the provision of a vertical antenna with an improved diverging array for intercepting, and redirecting a majority of the antenna's return currents before they dissipate upward creating unnecessary sky wave emissions.

It is also an object of the present invention to provide specific design criteria and parameters for a counterpoise or ground screen design that results in a relatively low level of current flow near the base of the antenna, thereby avoiding substantial (heat) losses customarily found in prior ground systems utilizing buried non-insulated wires.

It is a further object of the present invention to provide a vertical antenna system and design wherein a counterpoise is provided and as provided forms an integral part of the vertical antenna system.

A further object of the present invention resides in the provision of a vertical antenna system wherein the base impedance is determined, by the antenna design selected to work with the counterpoise element and is not directly dependent on the size, type and location of the earth or ground system underlying the antenna.

Still a further object of the present invention resides in the provision of a resonant free counterpoise so as to not adversely effect the performance of an associated antenna.

It is also an object of the present invention to provide a vertical antenna system with a counterpoise wherein the resulting angle of radiation from the antenna is both predictable, consistent, and controllable, and related ground wave emissions.

Another object of the present invention is to provide an antenna system with a very efficient artificial ground system in order that the height of the vertical antenna can be reduced and minimized without unduly effecting or distracting from the efficiency of the antenna system.

A further object of the present invention is to provide a vertical antenna system of the character referred to above that is designed such that the design lends itself to be constructed with excellent physical integrity.

It is also an object of the present invention to provide a vertical antenna with an artificial ground that is particularly suited for use in mobile installation. Another object of the present invention resides in the provision of a vertical antenna system and artificial ground therefore of the character referred to above that utilizes a counterpoise or ground plane wherein both said counterpoise or ground plane are used for both transmitting and receiving.

Still a further object of the present invention is to provide an artificial ground system for an antenna system that is of such high efficiency that the type and size of the particular antenna is of less importance than with conventional antenna system designs.

It is also an object of the present invention to provide a vertical antenna with an artificial ground system that is adaptable for use in a wide range of frequency applications such as an installation covering a number of acres for an AM broadcast station or for use with an antenna only a few inches high for land mobile units.

Still a further object of the present invention resides in the provision of a vertical antenna and artificial ground system of a design that is particularly suited for use wherein sky wave emissions are unwanted and troublesome, and beneficial to both, ground wave and sky wave as to form specific radiation pattern.

Another object of the present invention resides in the provision of a vertical antenna, and artificial ground system specifically designed to return currents from a vertical antenna as displacement currents rather than as conduction currents.

Other objects, and advantages of the present invention will become apparent from a study of the following description, and the accompanying drawings. Which are merely illustrative of possible arrangement of said invention.

The present invention, may of course, be carried out in other specific ways than those herein set forth without departing from the spirit and essential characteristics of the invention. The present embodiments are, therefore, to be considered in all respects as illustrative and not restrictive and all changes coming within the meaning and equivalency range of the appended claims are intended to be embraced therein.

TABLE 1
TYPICAL ANTENNA SYSTEM DIMENSIONS-
VERTICAL ANTENNA AND ARTIFICIAL GROUND

| | | ANTENNA | | | |
|---|---|---|---|---|---|
| OPERATING | | VERDICAL RADIATOR | DIVERGING ELEMENT | | |
| FREQUEENCY | RADIO | HEIGHT | LENGTH | | |
| MHZ. | SERVICE | FEET-(Wavelength) | TOTAL | UPPER | LOWER |
| 30 | Amateur | 8′(1/4) to 14′(5/8) | 8′(1/4) | 51.6″ | 44.4″ |
| 27.2 | Citizens | 9′(1/4) to 22.6′(5/8) | 9′(1/4) | 58″ | 52″ |
| 52.0 | Land Mob. | 4.7′(1/4) to 11.8′(5/8) | 4.7′(1/4) | 30.3″ | 26.1″ |
| 146.0 | Amateur | 1.7′(1/4) to 4.2′(5/8) | 1.7′(1/4) | 10.9″ | 9.5″ |
| 436.0 | Land Mob. | 7″(1/4) to 17″(5/8) | 7″(1/4) | 3.7″ | 3.3″ |
| 900.0 | Land Mob. | 3.3″(1/4) to 8.2″(5/8) | 3.3″(1/4) | 2.3″ | 1.77″ |

It is noted that two or more identical antenna systems, of the present invention can be connected to a transmitter in a phase relationship so as to form a specific radiation pattern. This is commonly done with amateur stations. Also directive parasitic arrays can be formed from arrays of two or more antennas. Here ¼ wavelength vertical antennas are used electrically as half of a ½ wavelength dipole. The second half of the dipole is created by use of the inverted ground plane system.

FIG. 1., Utilizing only to diverging elements 10., per vertical radiator element along the axis of said array. In this configuration, one antenna system is the basic radiating antenna while the other or others are tuned to act as parasitic directors or reflectors.

From the foregoing discussion and specification, it is appreciated that the present invention presents a very efficient, and effective vertical antenna system having an artificial ground. That may be in the form of a counterpoise or a ground plane. Of particular importance with respect to the present invention. Is the great deal of research, and testing conducted by applicant. In order to establish optimum design criteria for the counterpoise or ground plane. The design described and shown herein for the artificial ground system was reached after much research and testing. By applying these findings as discussed herein, one can produce a very economical, and efficient vertical antenna system with an artificial ground. Further it is appreciated that the present invention and the improved artificial ground system disclosed herein, is adaptable for use with a wide range of operating frequencies.

The present invention, may of course, be carried out in other specific ways than those herein set forth without departing from the spirit and essential characteristics of the invention. The present embodiments are, therefore, to be considered in all respects as illustrative and not restrictive and all changes coming within the meaning and equivalency range of the appended claims are intended to be embraced therein.

### BRIEF DESCRIPTION OF DRAWINGS

FIG. 1 Shows an antenna incorporating the present invention;

FIG. 2 Top view of an antenna displaying diverging elements in a favorable arrangement

FIG. 3. Cut away view showing top of vertical radiator with capacitance top hat.

FIG. 4. Cut away view showing side angle of invention,

FIG. 5. Cut away side view showing the base of exciting antenna, and mounting ring of said invention.

FIG. 6. Cut away side view from slightly above view with loading ring.

FIG. 7. Cut away side view showing an antenna incorporating the present invention with loading ring.

### REFERENCE NUMBERS IN DRAWINGS

10 Inverted Ground Plane System Diverging Elements

10(A) Inverted (Folded beneath) portion of 16.

13 Ground Mast, mounting point, or Guy Tower ect.

Transmission line (coaxial)

Mounting Bracket

Capacitance top hat with matching angles to elements 10

16(A) Lower portion of top hat 16.

18 Capacitance Matching network (loading ring)

20 Veridical Radiator elements

21 Locking connecters (nuts, bolts, screws, clamps ect.)

22 Mounting U-bolts

24 Feed point Transmission line (coaxial cable) connector PL259

### DESCRIPTION OF PREFERRED EMBODIMENT

### The Inverted Ground Plane System

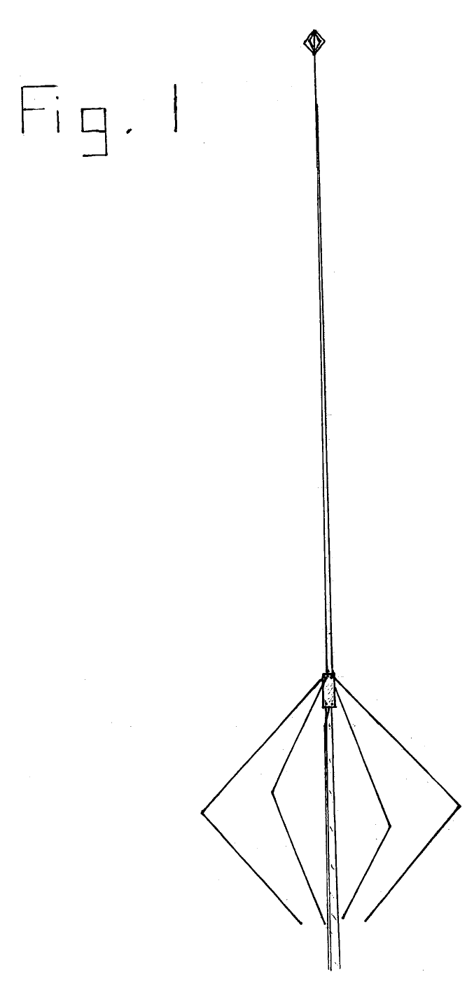

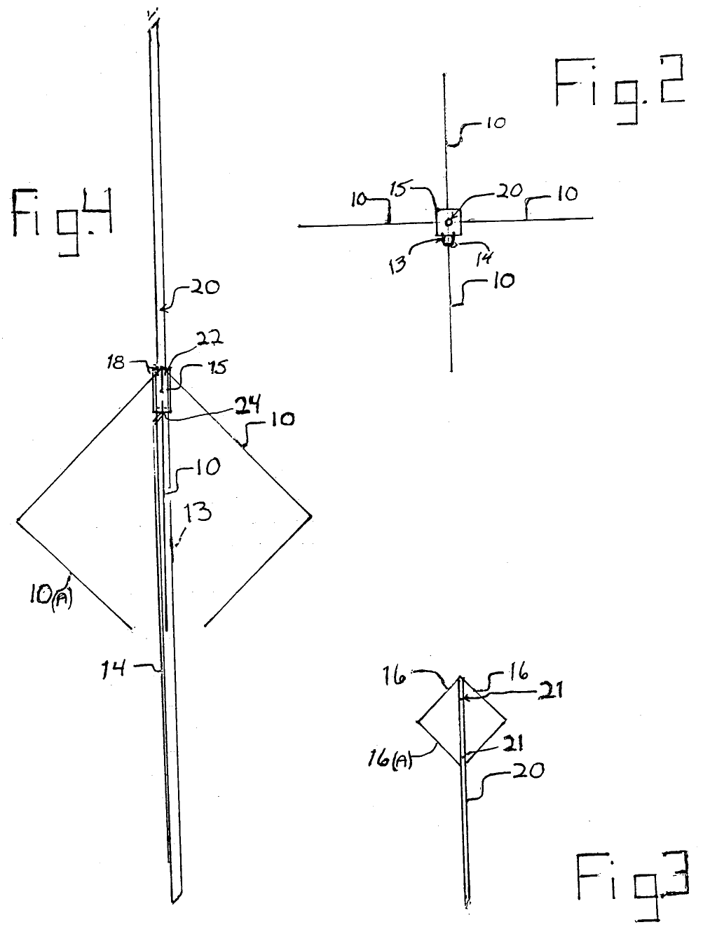

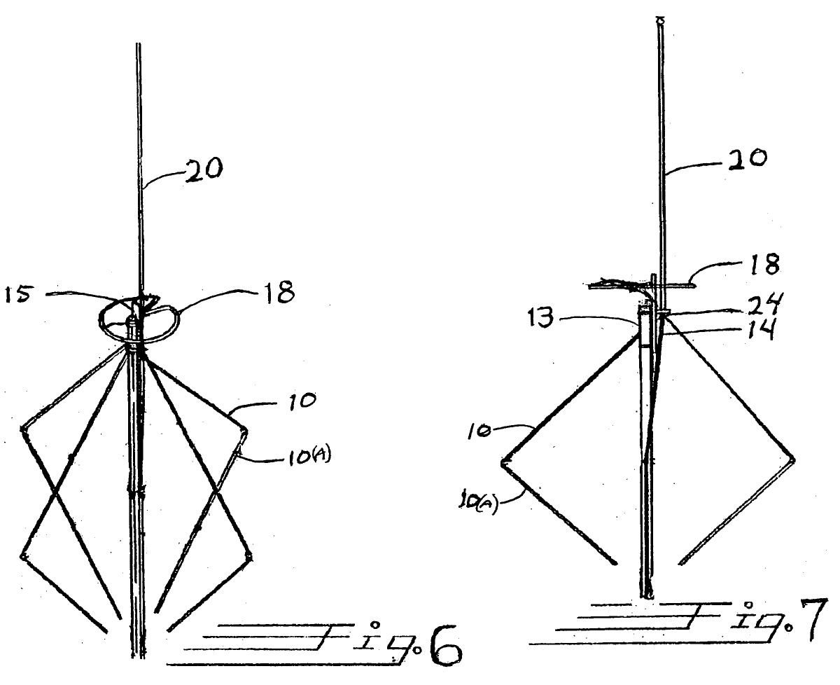

With further reference to the drawings, particularly FIGS. 1 through 6, there is shown therein a vertical antenna system, of the type that can be used by amateur broadcast stations. The antenna system shown herein is designed for relatively low frequencies, i.e. 50 MHz and less. Although exhibits potential for gain at much higher frequencies.

Viewing the vertical antenna system shown in FIG. 1, an entire vertical antenna system is indicated generally by symbol, and as FIG. 1. Illustrated herein extends over the earth or ground. Vertical antenna system FIG. 1., includes a vertical antenna FIG. 1., that extends upward from the ground at selected height. Antenna FIG. 1., is preferably supported by a support structure such as a guy tower and is/isn't insulated there from. The height of antenna FIG. 1., may preferably range from approximately one-fourth wave length to five-eighths wave length.

Shorter antennas are generally acceptable, but slightly less efficient. Antennas higher than five-eights wavelength radiate at an angle that is often unsatisfactory for most communication needs.

Extending radially from the base of antenna FIG. 1., is an artificial ground system in the form of a counterpoise. In the designs illustrated in FIGS. 1 through 4, the artificial ground system or counterpoise includes a set of 4 diverging elements. Extend outward and downward for about 50% to 65% of the total length of diverging element. Which is about ¼ wave length resident frequencies. Where as the differential of the opposing element portion lends itself to the natural percentages. Utilize by directional array antenna system.

For optimum performance, it has been determined that the total length of each respective diverging elements 10 should be at least 0.25 wavelength long. In the case of a part frequency such as 27 MHz to 32 MHz AM station, one would expect this distance to be about 7 feet to 8½ feet.

Diverging element upper ends 10 should be connected to mounting brackets 15 Forming a conductive connection between the capacitance matching element (loading ring) 10 and transmission line 14 Where overall lengths of vertical radiator, matching elements 18, (Loading Ring), and diverging elements 10. Combine forming a efficient radio signal emitter and receiver. With minimum amount of standing wave ratio (S.W.R.).

Defined between capacitance matcher 18: vertical radiator 20 diverging elements, 10 and the base of antenna FIG. 1., at feed point 18 It is appreciated that this feed point 18 is adapted to be operatively connected to a conventional transmitter in such a fashion that a transmitter effectively interconnects the diverging elements 10 and vertical radiator 20 antenna FIG. 1 with the counterpoise comprised of the plurality of insulated radial wires, 16

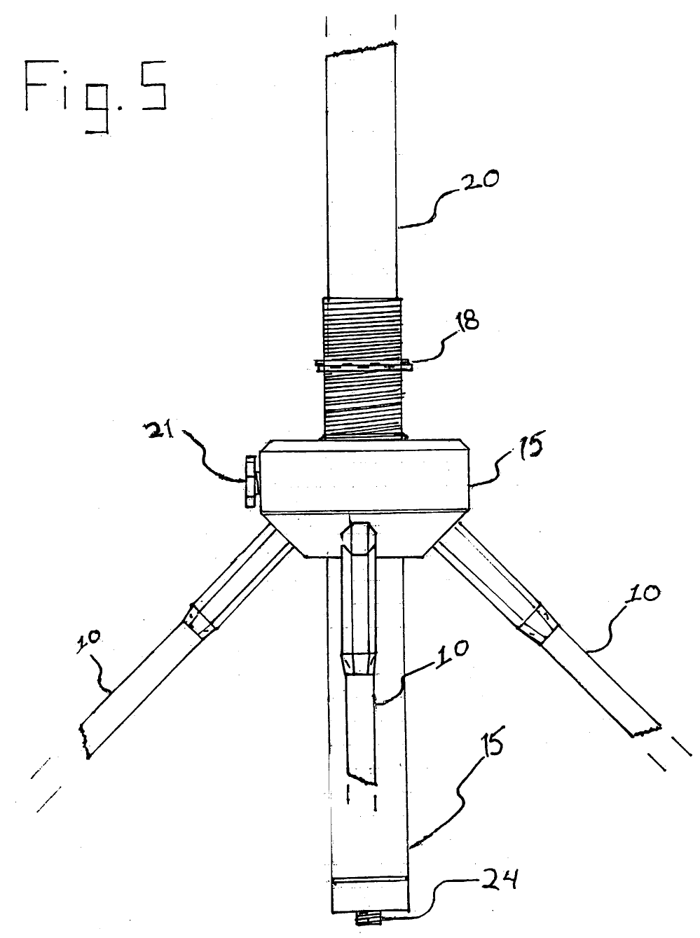

It should be pointed that if 4 diverging elements FIG. 5 is utility, the plurality of diverging element 10 should be connected at the upper ends, with an upper portion 10 being between about 2 degrees and 10 degrees longer. Wherein is directly related to the length of the lower portion, 10(a) and importantly the distance from opposing upper portio 10 that in one embodiment of said invention. Serving as a reflector 10 of signal emitted from opposing lower portion. 10(a) This embodiment will be a directive element wherein the ratio of an upperelemen, 10 and lower 10(a) and distances between would produce increases gain emitted from the ground plane, diverging emitter, and counterpoise wherein the ratio of an upper element 10 and lower. 10(a)

And distances between would produce increases gain emitted from the ground plane, diverging emitter. This type of radiator is particularly attractive inasmuch as its base impedance depends on capacitance matcher i.e. loading ring 18 diameter, shape, location, type or feed point opposed to a veridical radiator, 20 and the diverging elements 10 configured to take advantage of lowest S.W.R. widest band weight. lowering sky wave signal, improved ground wave emissions. Along with an ability to be tailored for users specific needs.

The design illustrated in FIG. 1 is contemplated to be especially useful in high frequency situations, for example applications above 25 MHz. It is anticipated that this type of antenna design would be effective, and efficient in “Land Mobile” use applications at approximately 900 MHz.

Table 1 which follows, shows typical dimensions for the vertical antenna systems described hereinabove. These dimensions of the antenna element may be reduced through the use of inductive, or capacitive loading of the vertical radiator. It is known that such loading enables the physical size of the radiator to be reduced while maintaining its resonant frequency.

A possible way to make invention (10) would be connecting invention (10) to the lower portion of a veridical diopole antenna (FIG. 1 #20) in the conventional manner (21).

Then connect the antenna-system in a suitable manner. To a transmitter, receiver, or transceiver. Via feed lines (twin lead, coax ect. (14)) terminated with standard connectors. (24)

Thus being able to transmit, and receive. Utilizing the benefits of The Inverted Ground Plane Systems, (10) and Kits design.

What is claimed is:

1. An improved vertical antenna's ground plane system comprising:
A vertical radiator element, capacitance load matching element, ground plane array element (diverging element), and capacitance top hat. Having similar shape and angles as the diverging elements.

2. An antenna and diverging elements as claimed in claim 1. The obtuse angle as said vertical radiating element, and diverging elements, is between about 125 degrees, and about 145 degrees until reaching a point between about 45% to 60% of resident fractional length. Folding about 80 degrees and 115 degrees beneath its self.

3. An antenna and diverging elements as claimed in claim 1. The angle between directly apposing diverging elements, is about 70 degrees and 105 degrees as with the apposing lower portions of diverging elements.

4. An antenna and diverging elements as claimed in claim 1. Capacitance top hat having similar angles as diverging elements.
